(19) United States
(12) Patent Application Publication
(10) Pub. No.: US 2024/0344393 A1
(43) Pub. Date: Oct. 17, 2024

(54) LADDER TABLE SYSTEMS AND RELATED METHODS

(71) Applicant: Little Giant Ladder Systems, LLC, Springville, UT (US)

(72) Inventors: N. Ryan Moss, Mapleton, UT (US); B. Scott Maxfield, Mapleton, UT (US); Travis Mittanck, Springville, UT (US)

(21) Appl. No.: 18/633,343

(22) Filed: Apr. 11, 2024

Related U.S. Application Data
(60) Provisional application No. 63/495,489, filed on Apr. 11, 2023.

(51) Int. Cl. E06C 1/393; E06C 1/20

(52) U.S. Cl. CPC E06C 1/393; E06C 1/20

(57) ABSTRACT

Ladder table systems can provide a table assembly for supporting objects and supplies on a ladder. The platform of the table can rotate between deployed and folded positions and can be supported or retained in either position. The table assembly may be removable from the rails of the ladder or attached to the rear side of a ladder not originally intended for operation with the table assembly. In a folded condition, the platform of the table assembly may substantially fill a volumetric space between a pair of rails and a pair of braces extending between the rails. The platform can also accommodate convenient carrying of the ladder system via hand-sized cutouts that permit a user to grasp a handle portion at or aligned with the center of gravity of the system.

### CROSS-REFERENCE TO RELATED APPLICATIONS

This claims priority to U.S. Provisional Patent Application No. 63/495,489, filed 11 Apr. 2023, the entire disclosure of which is hereby incorporated by reference.

### TECHNICAL FIELD

The present disclosure generally relates to tables and platforms for ladders, mobile platforms, scaffolds, accessories therefor, and similar structures.

### BACKGROUND

Ladders and related movable elevated platforms are conventionally utilized to provide a user thereof with improved access to elevated locations that might otherwise be inaccessible. Ladders come in many shapes and sizes, such as straight ladders, straight extension ladders, stepladders, and combination step and extension ladders. So-called combination ladders may incorporate, in a single ladder, many of the benefits of multiple ladder designs.

Ladders such as stepladders and step stools are highly utilized by various tradesman as well as homeowners. Such ladders are “self-supporting” in that they do not require the upper end of the ladder to be positioned against a supporting structure, such as against a wall or the edge of a roof. Rather, stepladders (including step stools) include multiple feet (typically either three or four) that are spaced from one another to provide a stable base or foundational structure to support the ladder and a user when placed on, for example, a floor or the ground. This enables a user of the ladder to gain access to elevated areas even though the accessed area may be, for example, in the middle of a room, away from walls or other potential supporting structures that are conventionally required when using a straight ladder or an extension ladder.

For these reasons and others, ladders configured as stepladders or step stools are popular configurations that comprise a large segment of the ladder market. However, there are always areas of potential improvement. For example, it is a continual desire to provide additional utility and convenience to users of the ladders. At times, ladder users may need to work from a ground surface surrounding the ladder, and the ladder may not be able to efficiently support and hold equipment from that position. It is also desirable to enable more efficient manufacturing, shipping, and storage of ladders and related accessories. Accordingly, there is a constant need for improvements to ladders and related movable elevated platforms.

### SUMMARY

One aspect of the present disclosure relates to a ladder system, comprising a ladder, comprising: a first pair of rails spaced apart from each other; at least two braces coupled with and extending between the first pair of rails; a table assembly, comprising: a platform pivotally coupled with the first pair of rails and rotatable relative to the first pair of rails between a first platform position and a second platform position; and at least one strut pivotally coupled with the platform and rotatable relative to the platform between a first strut position and a second strut position. When the at least one strut is in the first strut position, the at least one strut may be substantially parallel to the platform. When the platform is in the first platform position, the platform may lie substantially entirely between the first pair of rails, the platform may lie substantially entirely between the at least two braces, and the at least one strut may be in the first strut position. When the platform is in the second platform position, the platform may be substantially horizontally oriented relative to a gravitational direction. When the at least one strut is in the second strut position, the at least one strut may extend from the platform and contact the ladder.

In some embodiments, the ladder further comprises a second pair of rails and at least two rungs coupled with an extending between the second pair of rails, the first pair of rails and the second pair of rails being movably coupled with each other between an expanded configuration and a collapsed configuration.

In some embodiments, the at least one strut is in the second strut position, the at least one strut abuts a brace of the at least two braces.

In some embodiments, the ladder system further comprises a pair of brackets coupling the platform with the first pair of rails via a pair of pivot pins.

In some embodiments, the pair of brackets is detachable from the platform by operation of the pair of pivot pins.

In some embodiments, the platform includes a pair of lateral side surfaces respectively parallel to the first pair of rails.

In some embodiments, a pivot axis of the platform extends through a bottom half of the platform when the platform is in the first platform position.

In some embodiments, when the platform is in the second platform position, a first portion of the platform extends forward from the first pair of rails and a second portion of the platform extends rearward from the first pair of rails.

In some embodiments, the at least one strut is configured to prevent movement of the platform from the first platform position to the second platform position while the at least one strut is in the first strut position.

Another aspect of the disclosure relates to a ladder, comprising: a first pair of rails spaced apart from each other; a second pair of rails spaced apart from each other and rotatably coupled with the first pair of rails; at least two braces coupled with and extending between the first pair of rails; and a platform pivotally coupled with the first pair of rails and rotatable relative to the first pair of rails. The platform may have a perimeter substantially filling a space defined by the first pair of rails and the at least two braces.

In some embodiments, the perimeter defines a trapezoid.

In some embodiments, the platform is rotatable about at least one laterally movable pivot pin coupling the platform to at least one rail of the first pair of rails.

In some embodiments, the platform is rotatable between a first position filling the space and a second position extending horizontally from the first pair of rails when the first pair of rails and the second pair of rails are in a non-parallel-rail configuration.

In some embodiments, the platform is positioned rearward of rear surfaces of the first pair of rails when the platform is in a folded position.

In some embodiments, at least one lateral recess of the platform is aligned with a center of gravity of ladder system.

In some embodiments, a first end of the platform has a width different from a second end of the platform, the second end being pivotally coupled with the first pair of rails.

Yet another aspect of the disclosure relates to a platform system for a ladder, the platform system comprising: a platform defining a top surface, a bottom surface, and a perimeter extending around the top surface; at least one strut pivotally coupled with the platform by at least one pivotable upper hinge at a first end of the platform; and at least one pivot pin laterally extending from a second end of the platform, with the second end being positioned opposite the first end, and with the at least one pivot pin being rotatably connectable to a ladder. The at least one strut may be movable between a first strut position and a second strut position relative to the platform. In the first strut position, the at least one strut may be collapsed into a volumetric envelope defined between the top surface and the bottom surface. In the second strut position, the at least one strut may extend at an angle away from the bottom surface.

In some embodiments, the platform defines at least one channel, the at least one strut being received within the at least one channel while the at least one strut is in the first strut position.

In some embodiments, the at least one pivot pin is movable relative to the platform between an extended position and a retracted position.

In some embodiments, in the second strut position, the at least one strut is at a non-orthogonal angle relative to the platform.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a perspective view of a ladder system in a first configuration.

FIG. 2 is a left side view of the ladder system of FIG. 1

FIG. 3 is a left-facing central cross-section of a portion of the ladder system of FIG. 1.

FIG. 4 is a top view of the ladder system of FIG. 1

FIG. 5 is a perspective view of the ladder system of FIG. 1 in a second configuration.

FIG. 6 is a perspective view of the ladder system of FIG. 5.

FIG. 7 is a left-facing central cross-section of the ladder system of FIG. 5.

FIG. 8 is a perspective view of the ladder system of FIG. 1 in a third configuration.

FIG. 9 is a rear view of the ladder system of FIG. 8, taken perpendicular to the surface of the platform.

FIG. 10 is a left-facing central cross-section of the ladder system of FIG. 8.

FIG. 11 is a left-facing cross-section of the ladder system of FIG. 8 taken at a strut of the table assembly.

FIG. 12 is a perspective view of the ladder system of FIG. 1 with the table assembly removed.

FIG. 13 is a perspective view of the table assembly of the ladder system of FIG. 1.

FIG. 14 is a perspective view of the table assembly of FIG. 13 with the platform support in a deployed state.

FIG. 15 is a perspective view of the table assembly of FIG. 13 with the platform support in a folded state.

FIG. 16 is a bottom view of the table assembly of FIG. 15.

FIG. 17 is a bottom view of an interface between a pivot pin of the table assembly of FIG. 13 in a first position and a bracket.

FIG. 18 is a bottom view of the interface of FIG. 17 with the pivot pin in a second position.

FIG. 19 is a perspective view of a ladder system in a first configuration.

FIG. 20 is a top view of the ladder system of FIG. 19.

FIG. 21 is a perspective view of the ladder system of FIG. 19 in a second configuration.

FIG. 22 is a perspective view of the ladder system of FIG. 21.

FIG. 23 is a perspective view of the ladder system of FIG. 19 in a third configuration.

FIG. 24A is a left-facing cross-section of the ladder system of FIG. 21 with the strut in a deployed position.

FIG. 24B is a left-facing cross-section of the ladder system of FIG. 21 with the strut in a folded position.

FIG. 25 is a perspective view of a ladder system.

FIG. 26 is a left side view of the ladder system of FIG. 25.

FIG. 27 is a rear view of the ladder system of FIG. 25, taken perpendicular to the surface of the platform.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Various embodiments of devices usable with or as ladders, platforms, scaffolds, and related accessories and other components are described herein. The described embodiments are not mutually exclusive of each other. Rather, various features, components or elements of one described embodiment may be used in conjunction with features, components or elements of other described embodiments.

Ladder users often work at sites with limited furniture such as tables, countertops, work benches, and related equipment. Accordingly, they are too often forced to uncomfortably work leaning over, kneeling, or sitting on the ground when constructing or configuring equipment or other work product. For example, electricians may have to pre-wire components on the floor in an empty room and then use a ladder to position the components in a ceiling or high up on a wall. Embodiments of the present disclosure relate to tables and similar platforms that are positioned or positionable upon a ladder and can thereby act as a tabletop, work surface, countertop, work bench, or similar structure that allows users to support tools, and supplies at a naturally accessible level while standing on the surface on which the ladder is supported. Thus, the user is not obligated to repeatedly bend over or crouch to move or access equipment, thereby improving their efficiency and comfort at the worksite.

Table systems of the present disclosure may also be configured for convenient and compact storage with the ladder, wherein the table surface may be rotatable or otherwise folded from a deployed, substantially horizontal position into a more compact storage position against or within the rails of the ladder. This may beneficially reduce the overall size of the ladder when it in a folded or collapsed configuration as compared to when it is in an extended, unfolded, freestanding, or A-frame configuration. The ladder may therefore be easier to store and carry. The ladder may also be less expensive to ship or store in a warehouse, thereby benefiting a manufacturer, shipper, and seller of the ladder table system.

Table systems of the present disclosure may be embodied as a ladder comprising a folding or otherwise storable table device or as the table device itself. The table device may be removable from a ladder or attachable to a ladder via brackets.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

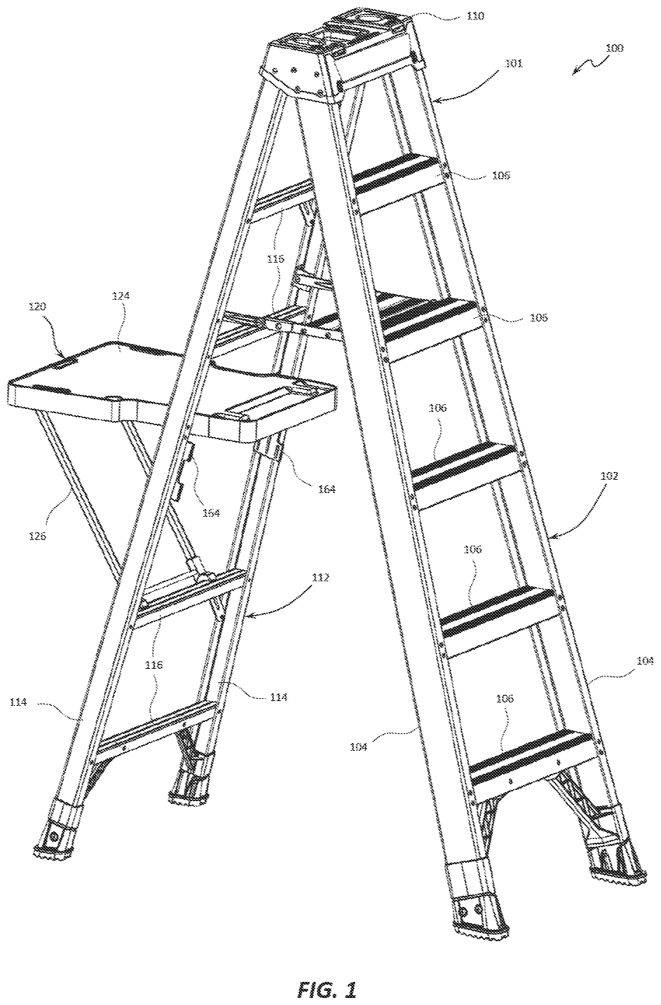

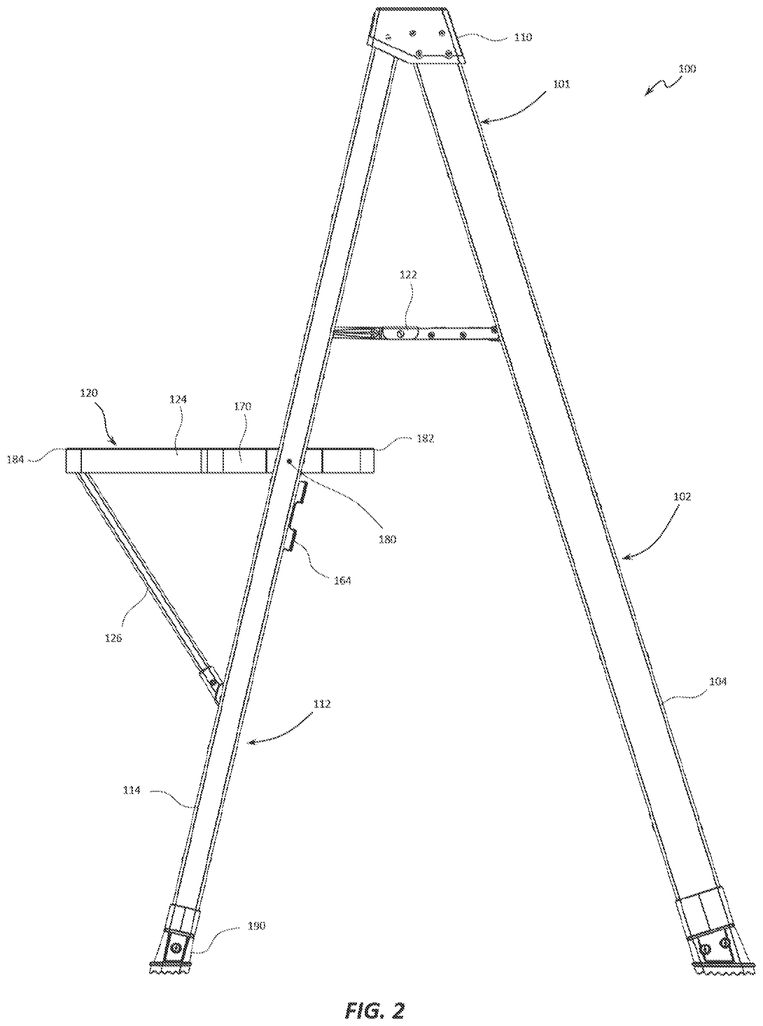

FIG. 1 is a perspective view of a ladder system 100 of an embodiment of the present disclosure shown in a standing configuration. FIG. 2 shows a left side view of the system 100. The standing configuration may be a user-supporting configuration, an A-frame configuration, a freestanding configuration, or a non-parallel-rail configuration. The system 100 can include a ladder 101 including a first assembly 102. The first assembly 102 may be a front assembly or user climbing assembly and may include a first pair of spaced apart rails 104 (e.g., a front pair of rails), a set of rungs 106 (e.g., front rungs, user-climbable steps, or foot-bracing members) extending between and coupled to the first pair of spaced apart rails 104, and a top cap 110 coupled with top ends of the rails 104.

The ladder 101 of the system 100 may also include a second assembly 112 pivotally coupled with the first assembly 102 (via the top cap 110) and including a second pair of spaced apart rails 114. A plurality of braces 116 may extend between the second pair of spaced apart rails 114. In some configurations, the braces 116 may be rungs configured for a user to climb the second assembly 112. In other configurations, such as the configuration shown in FIG. 1, the braces 116 may be included for stability of the rails 114 and are not intended for climbing by the user. In some embodiments, rungs or braces that are intended for climbing by a user may be evenly spaced apart along the longitudinal (substantially vertical) axis of the assembly 102 or 112, such as rungs 106, and rungs or braces that are not intended for climbing may be unevenly spaced along the longitudinal (substantially vertical) axis of the assembly, such as the spacing between braces 116. Furthermore, rungs or braces intended for climbing may also be spaced apart at a distance configured for a regular adult human user to climb step by step, such as the rungs 106 being spaced apart at a standard rung or step distance for a ladder. The second assembly 112 may include braces 116 that have an unequal distance between at least two of the braces 116, such as where table assembly 120 is positioned in ladder 101. The table assembly 120 may be part of the ladder system 100 and may be pivotally coupled with the rails 114 and supported by the ladder 101, as described in further detail elsewhere herein.

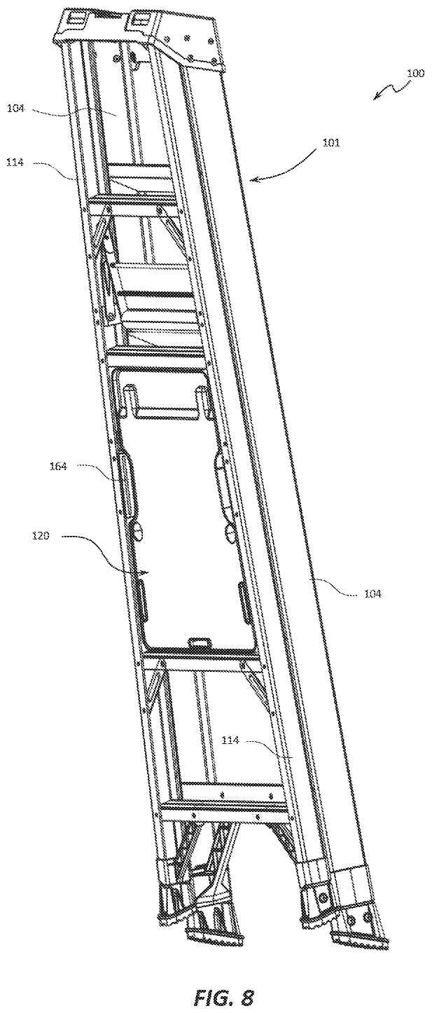

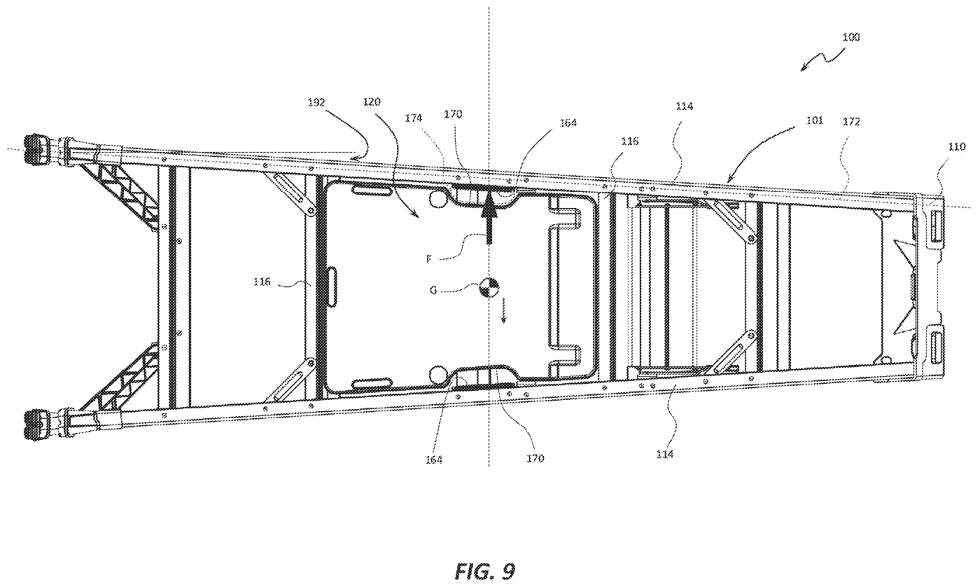

The first assembly 102 and the second assembly 112 may be pivotable relative to each other at the top cap 110. In some embodiments, the assemblies may be coupled by a hinge separate from the top cap 110. In any case, the first assembly 102 and second assembly 112 may be configured to transition between the standing configuration of FIG. 1 and the folded configuration shown in at least FIG. 8. The configuration of FIG. 8 can be referred to as a collapsed position, a storage position, a flattened position, a carrying position, or a folded position. While in the collapsed configuration, system 100 can be grasped by the user and carried with the rails 104, 114 being substantially horizontal. See FIG. 9. While in the standing configuration, the first and second assemblies 102, 112 may be held in their spread-apart spacing by one or more spreaders or foldable struts 122. See FIG. 2.

Furthermore, the rails 104, 114 and other structural components of the system 100 (e.g., the rungs 106) can comprise lightweight materials such as fiberglass, plastic, or aluminum, thereby minimizing weight and improving portability of the system as a whole, especially if the user needs to lift the entire system from the floor from time to time. Weight reduction can also reduce shipping and manufacturing costs to enable lower transportation and building costs to makers and users of the system.

Referring again to FIGS. 1-2, the ladder 101 may be coupled with the table assembly 120 so that the table assembly 120 provides a platform 124 supported by the rails 114 and by at least one brace 116 of the second assembly 112 (via a platform support 126 or leg). The table assembly 120 may be positioned on the ladder 101 so as to provide a working surface as the top surface of the platform 124. In some embodiments, the top surface of the platform 124 may be positioned at a conventional height for work surfaces, countertops, or work benches, such as, for example, about 36 inches vertically above a horizontal ground surface supporting the ladder 101. In some embodiments, the ladder 101 may comprise multiple table assemblies positioned at different heights. In some embodiments, the ladder may comprise a table assembly 120 that is repositionable relative to the rails 114, such as by being attachable at a plurality of different discrete heights relative to the ground surface supporting the ladder 101 or by being attachable at a user-selected height along a continuum or range of heights from the ground surface. Accordingly, the system 100 may be customized or optimized for various tasks and activities by those using the table assembly 120.

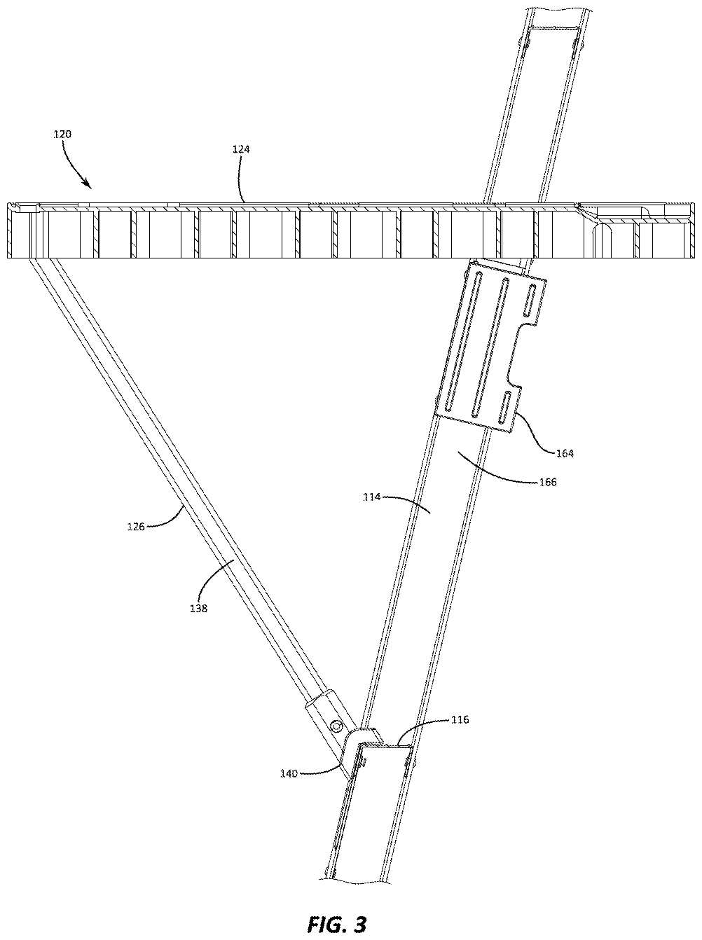

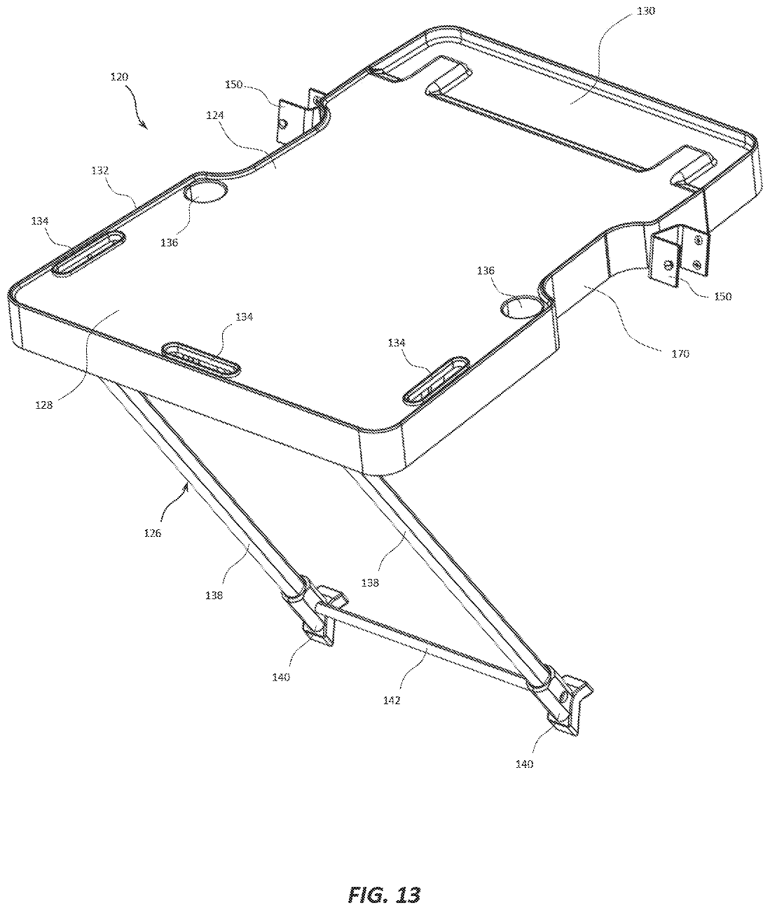

The platform 124 may comprise and provide a rigid, substantially flat top surface 128. See FIG. 13. In some configurations, the top surface 128 may be formed by a network or mesh of bars, rods, and similar members that collectively form a horizontal support surface when the table assembly 120 is in the position shown in FIG. 3. The network or mesh can include openings or slots through which liquids or small debris can pass. In some configurations, the top surface 128 may be substantially water tight, integral, and continuous, wherein the top surface can support and contain liquids and small debris, such as top surface 128 shown in FIG. 13.

The top surface 128 may also comprise a recessed portion 130 positioned at a lower elevation or that is deeper than other portions of the top surface 128. The recessed portion 130 may be used to contain objects and prevent them from rolling off of the platform 124 unintentionally. Additionally, a lip or rim 132 can extend around the edges or perimeter of the top surface 128 in a manner raised relative to the center of the top surface 128 in order to limit objects from rolling or sliding off of the top surface 128.

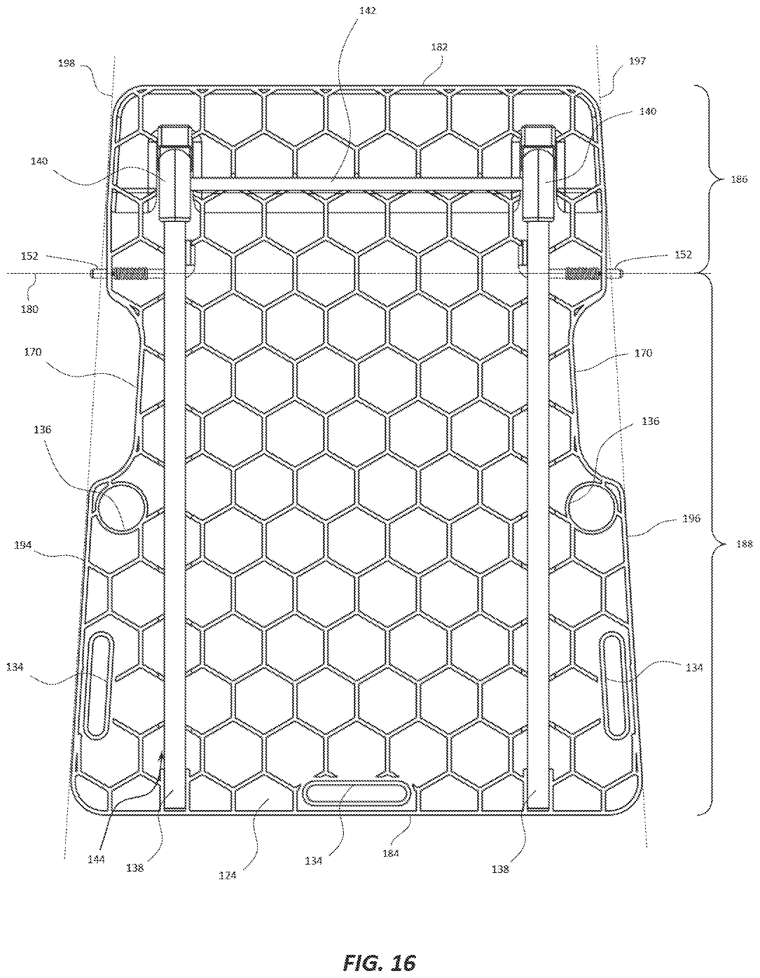

The platform 124 may include a set of openings (e.g., slots 134 and round apertures/openings 136). See FIGS. 13 and 16. The openings may pass through the top surface 128 and, in some embodiments, may also pass through the bottom surface of the platform 124, thereby forming through-holes. The openings can provide areas for holding tools and supplies (e.g., a hammer handle or screwdriver extending through the opening) to help organize and add stability to user equipment used on the table assembly 120.

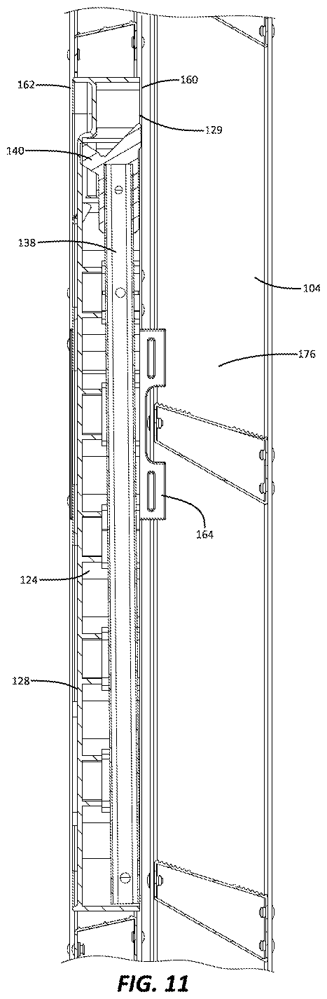

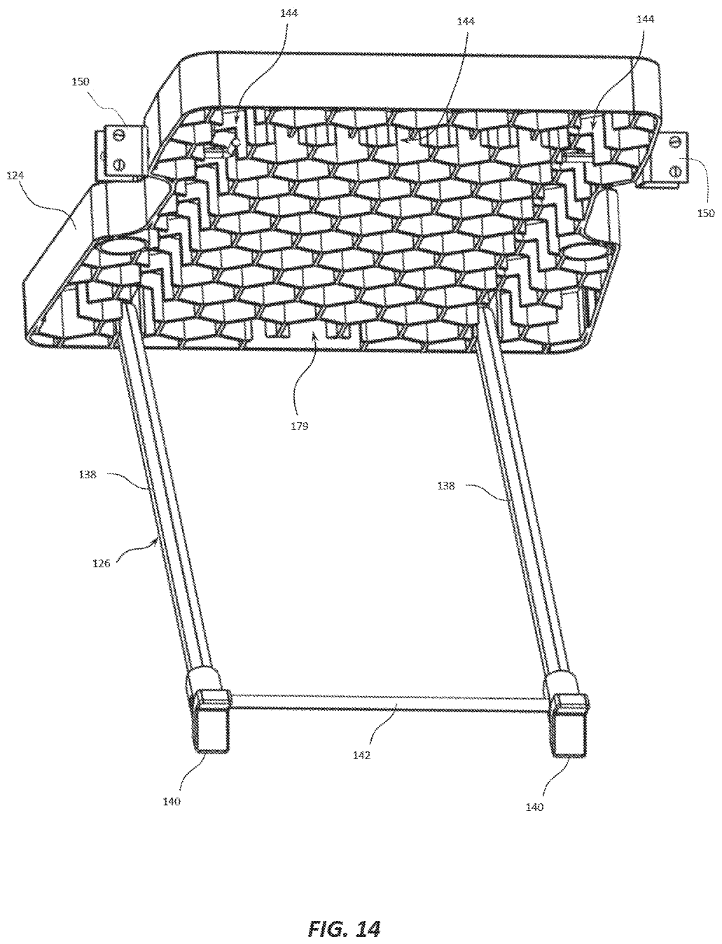

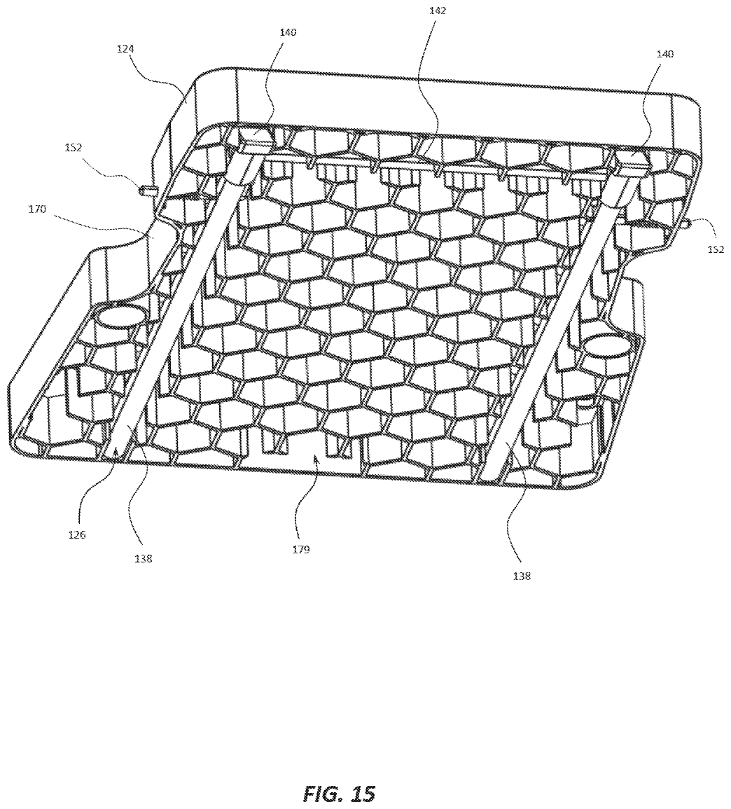

The platform support 126 is shown in detail in FIGS. 13 and 14. The platform support 126 may include a pair of pivotable struts 138, a corresponding pair of feet 140, and a cross-member 142. The struts 138 may be pivotally coupled with the platform 124 (e.g., at upper hinges directly coupled with the platform 124) to allow the platform support 126 to pivot between a deployed configuration (e.g., as shown in FIGS. 1, 13, and 14) and a folded or storage configuration (e.g., as shown in FIGS. 15 and 16). The bottom side of the platform 124 may comprise a series of channels 144 or recesses (see FIG. 14) configured to receive the platform support 126 when it is in the collapsed configuration. The channels 144 may form a three-sided shape (e.g., a U-shape) to receive the struts 138, feet 140, and cross-member 142 within the thickness of the platform 124. In some embodiments, the platform support 126 may entirely fit within a volumetric envelope defined between the top surface and bottom surface of the platform 124 when in the collapsed configuration. In other words, the platform support 126 may be entirely disposed between the top surface 128 and bottom-most surface 129 of the platform 124, as shown in FIG. 11. In some configurations, the entire platform support 126 may be disposed within the volumetric envelope of the top and bottom surfaces of the platform 124. In various embodiments, only the struts 138 and cross-member 142 may be within the volumetric envelope.

When the platform support 126 is in a deployed condition, with the feet 140 rotated away from the platform 124, the feet 140 may engage a brace 116 of the second assembly 112. See FIG. 3. A foot 140 may comprise a curved or angled engagement surface configured to engage multiple sides of the brace 116, such as by engaging a top surface of the brace 116 and a substantially laterally-facing surface of the brace 116. In this manner, the foot 140 can limit movement of the strut 138 to which it is coupled in multiple directions, such as by limiting vertical downward movement via engagement with a top surface of the brace 116 and by limiting forward movement of the brace 116 (i.e., toward the first assembly 102) via engagement with the lateral rear side of the brace 116.

The foot 140 may comprise a slip-resistant or high-friction material (e.g., rubber or polyurethane) to assist in keeping the foot 140 stationary and stable while the table assembly 120 is being used. In some embodiments, the foot 140 may comprise a hook or pin that is insertable or attachable to the brace 116 to mechanically lock the foot 140 to the brace 116 (e.g., by inserting the hook or pin into an opening in the brace 116). Thus, the foot 140 can improve stability and weight-bearing capacity of the table assembly 120. Furthermore, although the system 100 shows two feet 140, it will be understood that one foot or more than two feet can be implemented with the platform support 126 as needed to secure the table assembly 120 to various types of ladders and braces 116.

Struts 138 may be rigid members pivotally attached to the platform 124 and capable of bearing weight applied to the platform 124. The struts 138 may have a longitudinal length configured to position the platform 124 in a substantially level and horizontal position when the platform 124 is fully deployed and when the rails 114 are in their upright and standing configuration. Thus, the length of the struts 138 may be based on the angle of the rails 114 and the distance between pivot brackets of the platform 124 (e.g., 150 escribed elsewhere herein) and the brace 116 (and/or the foot 140 when coupled with the brace 116). The range of rotation of the struts 138 relative to the platform 124 can extend from the collapsed position (FIG. 15) to a deployed position (FIGS. 3 and 13). In some arrangements, the range of rotation can extend beyond the deployed position relative to the collapsed position, wherein the struts 138 can pivot out further than needed for the user's convenience in setting up the platform 124 in its horizontal deployed configuration. In some examples, the range of rotation can be limited to a non-orthogonal maximum displacement angle between the platform 124 and the struts 138, as shown, for example, in FIGS. 2 and 3. Thus, the struts 138 and platform 124 can define an overhang that allows a user to move objects (e.g., a chair under platform support 126 in FIG. 2, even if the chair is wider than the table assembly 120) horizontally underneath the platform without being horizontally blocked by vertical struts 138.

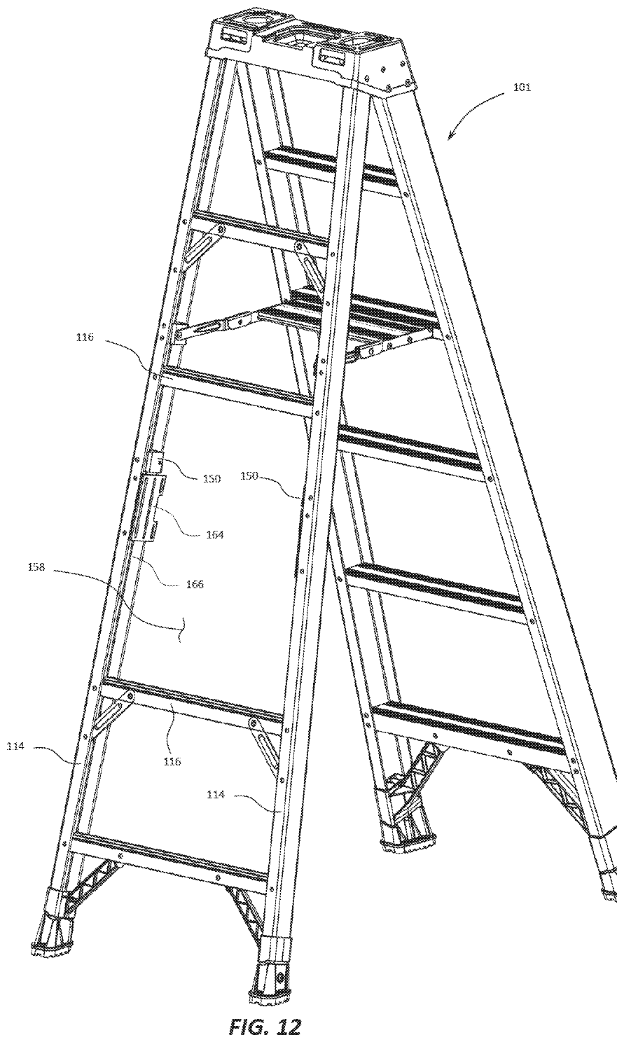

The platform 124 of the table assembly 120 may be pivotable relative to the rails 114. For instance, a pair of brackets 150 may be coupled to the rails 114 to which the platform 124 may be pivotally attached. The brackets 150 are shown in FIG. 12 with the table assembly 120 removed from the ladder 101, and the brackets 150 are shown coupled with the table assembly 120 in FIGS. 13-14. The brackets 150 may be pivot brackets that engage with at least one pivot pin or axle of the platform 124 and that define an axis of rotation of the platform 124 as it moves between a deployed configuration and a folded configuration relative to the rails 114. Accordingly, the brackets 150 may each define an aperture for receiving a pivot pin or axle and in which the pivot pin or axle can rotate or slide as the platform 124 moves. In some arrangements, the brackets 150 may be attached to the rails 114 via fasteners, adhesives, welding, etc. In some embodiments, the brackets 150 may be integrated with the rails 114, wherein the openings provided by the brackets 150 are instead formed in the surface of the rails 114.

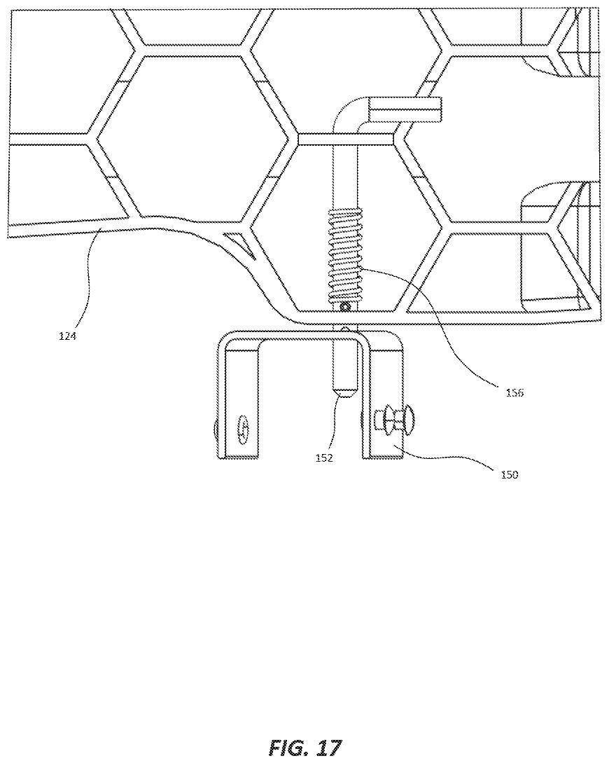

FIGS. 16 and 17 show pivot pins 152 coupled with the platform 124 that enable attachment to the brackets 150 and rotation of the platform 124 relative to the brackets 150. The pivot pins 152 may be configured to extend laterally away from the sides of the platform 124 to engage and extend into the brackets 150. The pivot pins 152 may therefore form a common axis of rotation for the platform that extends across the width of the platform 124 and into the brackets 150 and/or rails 114.

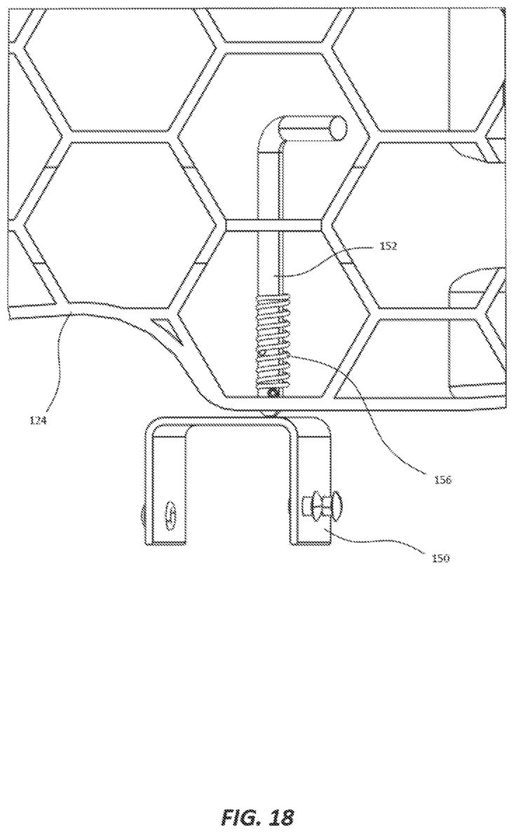

The pivot pins 152 may be biased outward by respective biasing members 156 (e.g., springs). See FIGS. 17 and 18. The biasing members 156 may drive the pins 152 toward the openings in the brackets 150 and can help ensure the platform 124 does not inadvertently disconnect from the brackets 150. The biasing members 156 may also enable a user to withdraw the pivot pins 152, such as by withdrawing a pivot pin 152 from the extended position of FIG. 17 to the retracted position of FIG. 18, wherein the pivot pins 152 are clear of the bracket 150, and the table assembly 120 can therefore be removed from the ladder 101. FIGS. 13-16 show the table assembly 120 removed from the ladder 101, and FIG. 12 shows the ladder 101 with the table assembly 120 removed from it. In this manner, the table assembly 120 can be referred to as being removable or selectively releasable from the ladder 101. The table assembly 120 can also be referred to as being pivotable or rotatable relative to the ladder 101 due to the pivot pins 152 enabling the platform to be turned or rotated relative to the ladder 101.

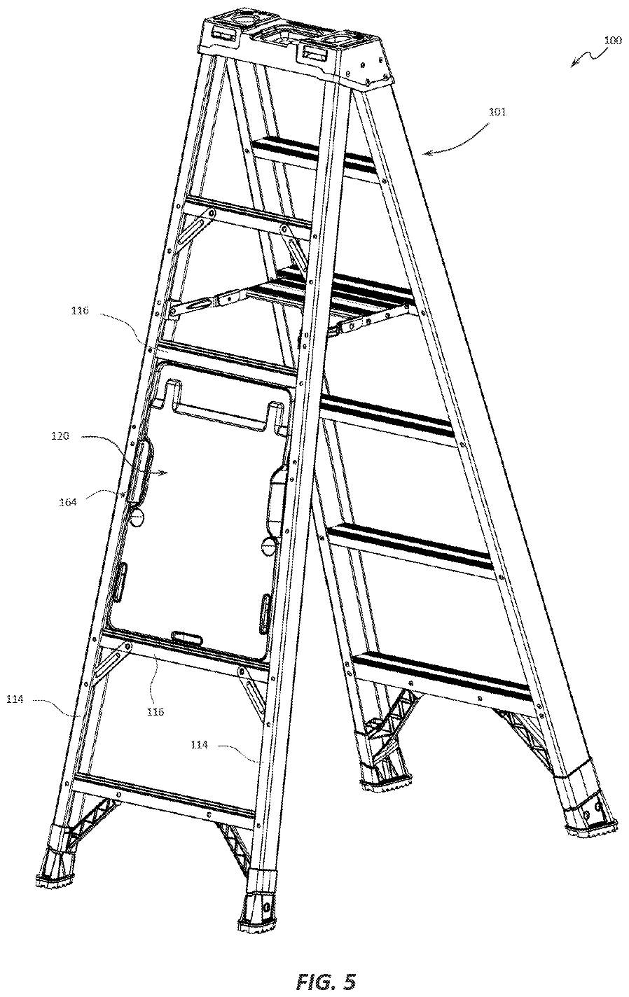

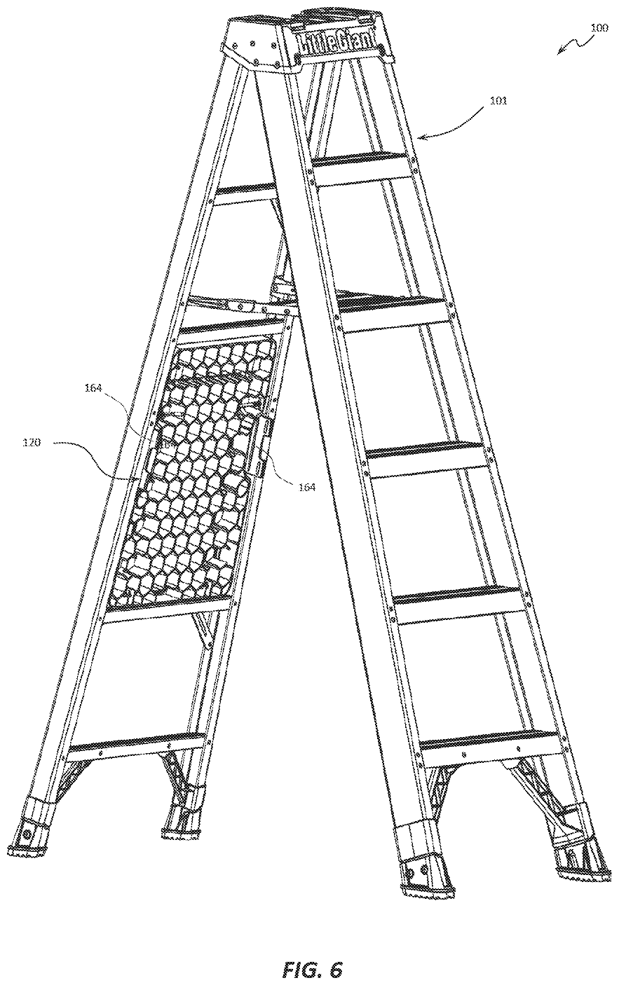

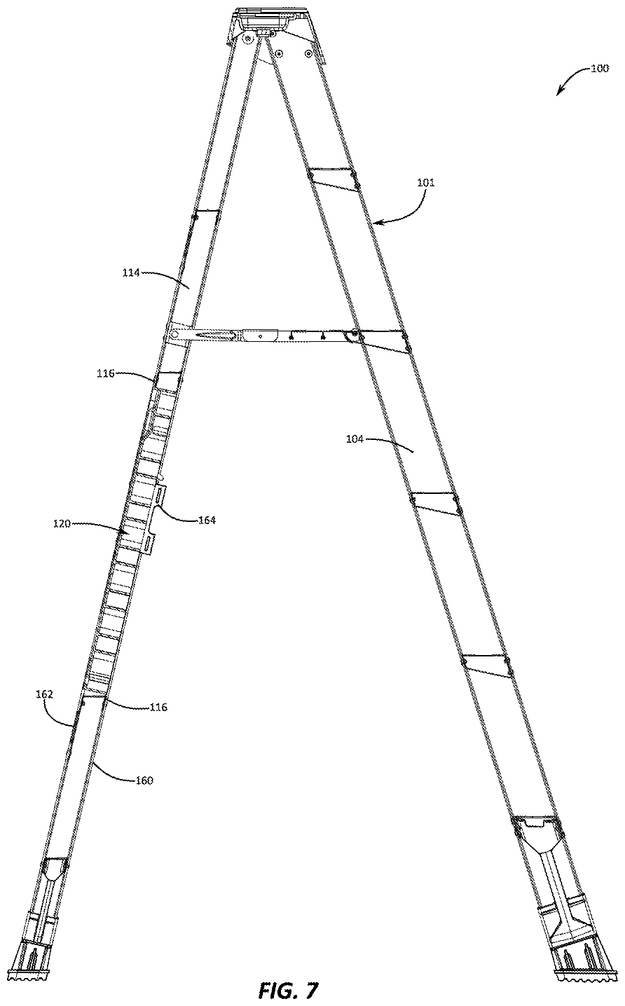

As shown in FIGS. 1-4, the table assembly 120 may be configured in a horizontal position. The horizontal position may be a support position, a deployed position, or a tabletop support position. Upon release of the platform support 126 from a brace 116, the platform 124 may be rotated to a substantially vertical position while the ladder 101 is still in the standing position, as shown in FIGS. 5-7. The platform support 126 may be stowed in the channels 144 of the platform 124. The substantially vertical position of the table assembly 120 may be a folded position or a storage position. In the storage position, the table assembly 120 may lie entirely within an opening (e.g., opening 158 in FIG. 12) that is defined on its left and right lateral sides by the rear rails 114 and is defined on its top and bottom sides by consecutive braces 116, as shown in FIG. 12. As shown in the central left-facing cross-section of FIG. 7, the table assembly 120 may also fit entirely within a volumetric envelope defined between a front plane parallel to the front-facing side 160 of the rear rails 114 and by a rear plane parallel to the rear-facing side 162 of the rear rails 114. This may allow the table assembly 120 to take up minimal space in the overall system 100 when in the storage or folded position. Additionally, this may allow the system 100 to be shipped and stored in a compact space defined only by the size of the rails 114, 104 rather than needing to accommodate the table assembly 120 in any direction. The system 100 may also benefit from this configuration by being able to slide on the rear surface of the rear rails 114 (e.g., when the ladder 101 is also in its folded configuration, as shown in FIGS. 8-11) without being caught or snagged on parts of the table assembly 120 that could otherwise protrude from the rear- facing sides 162.

As shown in FIGS. 8-11, the system 100 may be configured in an overall folded or collapsed condition, wherein the table assembly 120 is in a folded configuration and with the ladder 101 is also in a folded configuration. In this state, the rails 104, 114, platform 124, and platform support 126 are all oriented substantially parallel to each other, and the feet of the rails 104, 114 are positioned proximate to each other as well. The system 100 can be placed in this compact configuration for storage, shipping, or carrying by the user.

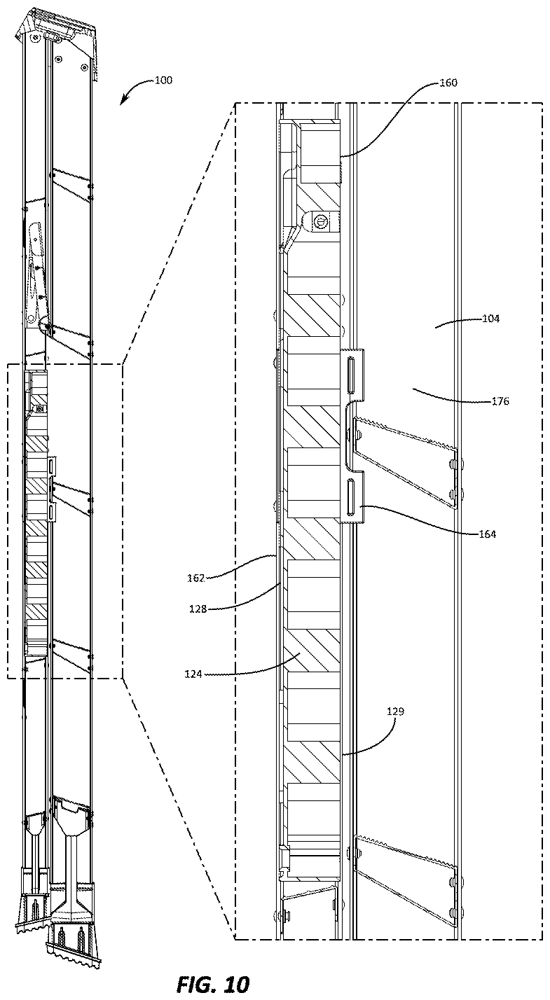

In some embodiments, the ladder 101 may comprise a pair of handles 164 or grips configured to be contacted by the hands or fingers of a user carrying the system 100. The handles 164 may include flaps or platforms that extend across the inward-facing C-shaped channels 166 of the rear rails 114 (see FIGS. 3 and 12) and therefore provide a comfortable place for the user to grasp the ladder 101 as it is being carried while being held horizontally (e.g., as shown in FIG. 9). The user may place his or her hand on a handle 164 and lift the ladder 101 without having to extend his or her fingers into the channel 166 of the rear rail 114. Additionally, the handle 164 may at least partially extend past the front-facing side of the rear rail 114 and into the volumetric envelope defined between the front and rear surfaces of the front rails 104, e.g., into or laterally aligned with channel 176 between the front rails 104, as shown in FIG. 10. Thus, the handle 164 may assist in keeping the front rails 104 held against or approximate to the rear rails 114 while the ladder 101 is being carried, either by the user's fingertips or a tip portion of the handle 164 extending into a channel of the front rails 104, thereby limiting movement of the front rails 104 relative to the rear rails 114 due to contact with the user's fingers or with the handle 164.

The handles 164 may be positioned on the ladder 101 in a position intended to coincide with the center of gravity of the system 100. Thus, when the user grips a handle 164 and carries the ladder 101, the upward force F applied by the user (see FIG. 9) may align with the center of gravity G of the system 100. The platform 124 may comprise corresponding lateral recesses 170 that are configured to align with the handles 164 and the center of gravity G of the system 100 when the platform 124 is in its folded or collapsed condition, as shown in FIG. 9. The lateral recesses 170 may be cutouts, coves, or molded narrowed portions of the platform 124. In some embodiments, the recesses 170 are mirror images of each other across a central longitudinal plane of the platform 124.

A lateral recess 170, in combination with its adjacent rear rail 114, may define a passage 174 or opening through which the user's fingers or hand may extend to contact and grasp the nearby handle 164. A width dimension of the passage for the user may be elongated parallel to the longitudinal axis 172 of the rail 114 relative to a direction perpendicular to the longitudinal axis 172 so as to minimize the amount of surface area of the top surface 128 of the platform 124 that is lost due to the inclusion of the recess 170. In some embodiments, the dimensions of the passage may be configured to receive four side-by-side aligned fingers of the user's hand. The lateral recess 170 may therefore enable a user to carry the system 100 using the handle 164 in a balanced manner, wherein half of the weight of the system 100 is on one side of the user's hand (e.g., toward the top cap side of the ladder 101) and the other half is on the other side of the user's hand (e.g., toward the foot side of the ladder 101). The user may be enabled to comfortably move the system 100 without needing multiple hands or externally-extending handles.

Additionally, as shown in FIG. 10, while the system 100 is in the fully collapsed configuration, the platform 124 may remain entirely within the volumetric envelope defined between the front-facing surfaces 160 and the rear-facing surfaces 162 of the rear rails 114.

As explained above, the platform 124 may comprise a top surface 128 that extends substantially horizontally while in a deployed condition. The top surface 128 may be positioned on a top panel of the platform 124 that is mostly flat, solid, continuous, and liquid-tight (aside from the set of openings/slots 134, 136). Below the top panel, the platform 124 may comprise a lattice (e.g., 179 in FIGS. 14-15), array, or honeycomb-like structure of fins, reinforcement walls, similar members, or combinations thereof configured to provide rigidity to the platform 124 while limiting its weight. The channels 144 may be defined through the lattice, as shown in FIGS. 14 and 15. The bottom ends of the lattice walls may define the bottom surface 129 of the platform 124. In some embodiments, the bottom edge of the side walls of the platform 124 (i.e., the walls around the perimeter of the top surface 128 and following lip or rim 132) may define the bottom surface 129 of the platform. The lattice walls may provide openings for the pivotal attachment of the struts 138 or pivot pins 152 to the platform 124.

As shown in at least FIG. 2, the platform 124 may have a pivot axis 180 (e.g., defined through pivot pins 152) that is positioned within the volumetric envelope defined between the front and rear surfaces of the rear rails 114. The pivot axis 180 is also shown in FIG. 16. The platform 124 therefore has a pivot axis 180 that is positioned significantly spaced away from an inner edge 182 or outer edge 184 of the platform 124. Thus, the platform 124 may comprise a first portion 186 extending inward from the rails 114 and pivot axis 180 and a second portion 188 extending outward from the rails 114 and pivot axis 180 while in the deployed condition. See FIG. 16. The inward-extending first portion 186 may position the inner edge 182 between the front- facing surfaces 160 of the rear rails 114 and the rear-facing surfaces 162 of the front rails 104. As a result, the front-to-back-measured width of the platform 124 (i.e., the length from edge 182 to edge 184) may extend over a rear foot 190 of the ladder 101. The center of that width may lie substantially vertically over the center of the rear foot 190. Accordingly, the platform 124 may provide ability to hold weight without giving the system 100 a propensity to tip over (e.g., with edge 184 leading the tipping movement) due to the platform 124 being centrally located over the ground contact position of the rear foot 190. Furthermore, the inward extension of the first portion 186 may enable the platform 124 to be longer than it would otherwise be (e.g., if its width only extended from the pivot axis 180 to edge 184) without sacrificing stability of the system 100 (as would be the case if the platform 124 extended further outward past edge 184). The first portion 186 may also enable the user to more easily transition the platform 124 from the storage position to the deployed position because the first portion 186 can provide a surface against which the user can press to rotate the outer edge 184 of the platform 124 upward. A user can therefore deploy the platform 124 without having to bend over or reach down to edge 184.

Additionally, the positioning of the pivot axis 180 can allow the edges 182, 184 of the platform 124 to substantially entirely fill the longitudinal/vertical space between the adjacent upper and lower braces 116 of the second assembly 112. As shown in FIGS. 5-11, the table assembly 120 may be sized and shaped so that its four main outer walls can move a folded position where they are respectively parallel and adjacent to the rails 114 and braces 116 surrounding the opening 158 (see FIG. 12) in the second assembly 112. As seen in FIG. 9, the rear rails 114 may be angled relative to each other and/or relative to a central longitudinal axis of the platform 124 and second assembly 112. For example, the rails 114 may extend at a non-zero angle 192 shown in FIG. 9. The rails 114 may be referred to as being flared or widened at their bottom ends. Accordingly, the platform 124 may be arranged with left and right side surfaces 194, 196 (see FIG. 16) that are parallel to the longitudinal axes of their adjacent rear rails 114. In some embodiments, the left and right side surfaces 194, 196 may define respective left and right planes 197, 198 (see FIG. 16) coplanar with the left and right side surfaces 194, 196 and which are non-parallel/angled relative to each other at the same non-parallel angle as the rails 114. The left and right planes 197, 198, front-facing and rear-facing surfaces 160, 162, and the braces 116 at the opening 158 may collectively form a three-dimensional volumetric envelope within which the platform 124 substantially entirely occupies, aside from its pair of recesses 170, through-hole openings/slots 134, 136, and the voids within the lattice of the underside of the platform 124. Thus, the platform 124 can have a nearly maximized top surface area that is still storable within the volumetric envelope defined between of the rear rails 114 and braces 116 and that does not interfere with carrying the system 100 at handles 164/aligned with its center of gravity G.

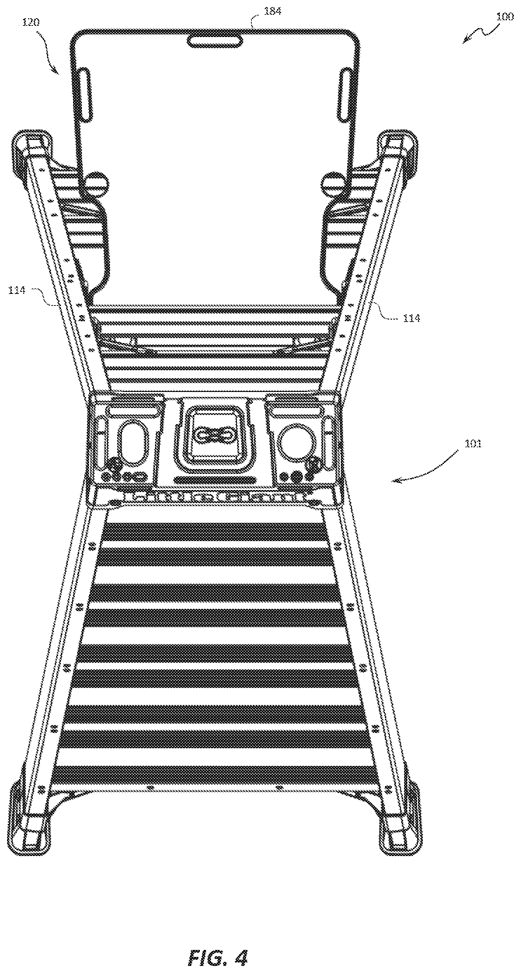

The top perimeter of the platform 124 may substantially form a trapezoid. As shown in the top view of FIG. 4, the outer edge 184 may be wider than the distance between the rails 114 at brackets 150 when the table assembly 120 is deployed. This may beneficially allow more objects to be stored conveniently on the top surface 128 and to be accessible from around the ladder 101.

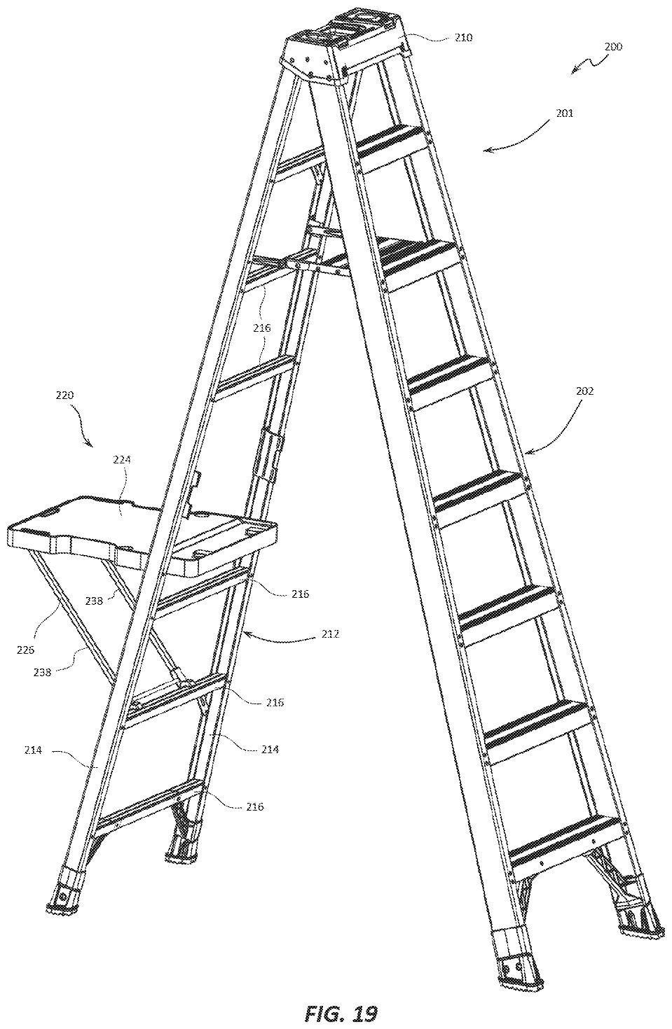

The features and structures of FIG. 1 may be implemented in various forms and combinations. Thus, although system 100 shows a stepladder, it will be understood that the table assembly 120 may be implemented in other types of ladders (e.g., articulating ladders, extension ladders, or combination ladders), scaffolds, elevated platforms, and combinations thereof. Additionally, the table assembly 120 may be implemented as a stand-alone product, such as a product that is attachable to an existing or third-party-made ladder or similar device. Furthermore, although the ladder 101 includes five rungs 106 and four braces 116, any ladder implementing features of the system 100 may include more or fewer rungs or braces to accommodate different use cases and sizes of systems. For instance, as shown in FIGS. 19-23, a system 200 is shown that corresponds to system 100 in many respects and may have many of the same parts and features while also implementing a different number and positioning of rungs and braces that allow the ladder 201 thereof to be optimized taller than ladder 101.

System 200 therefore includes a ladder 201 with a first assembly 202 corresponding to, and having features in common with, the first assembly 102 and a second assembly 212 corresponding to, and having features in common with, the second assembly 112. A table assembly 220 is positioned between rear rails 214 and braces 216, and has features in common with, table assembly 120. A platform 224 is configurable in a horizontal position that is supported by a platform support 226 corresponding to, and having features in common with, platform 124 and platform support 126. The systems 100, 200 may have other features and components in common, as shown in the figures.

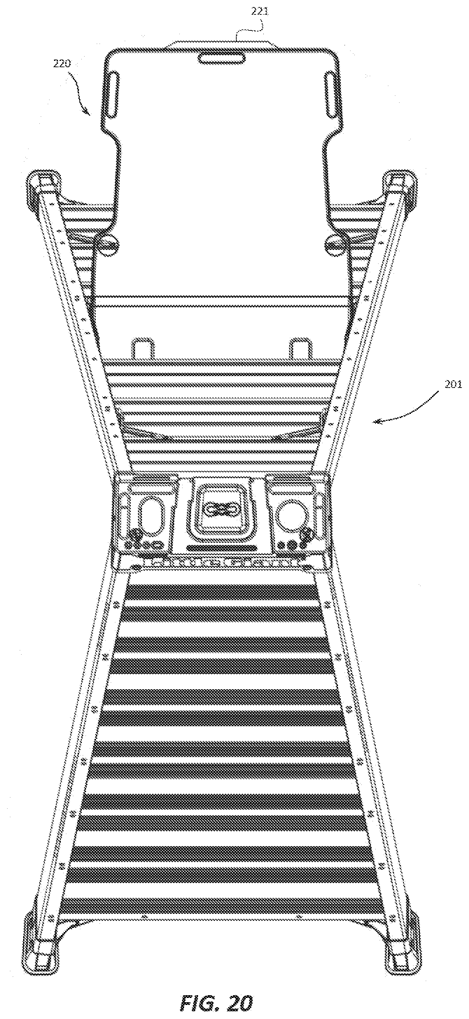

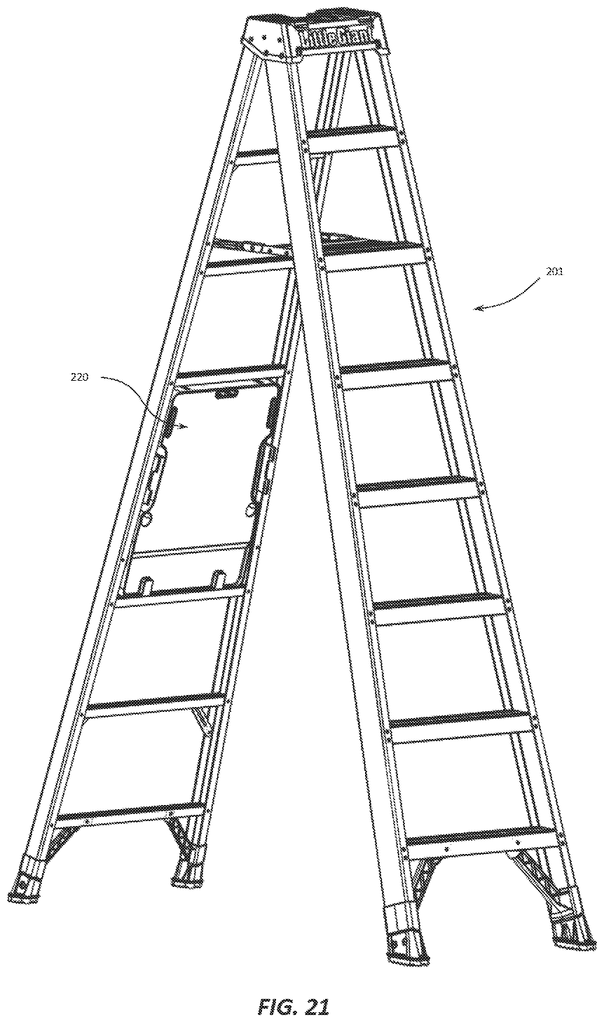

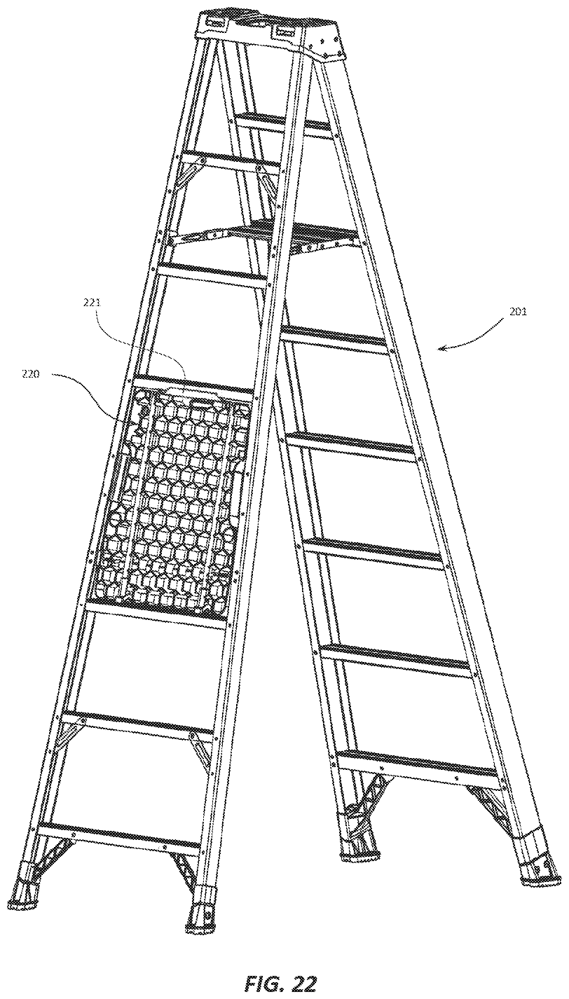

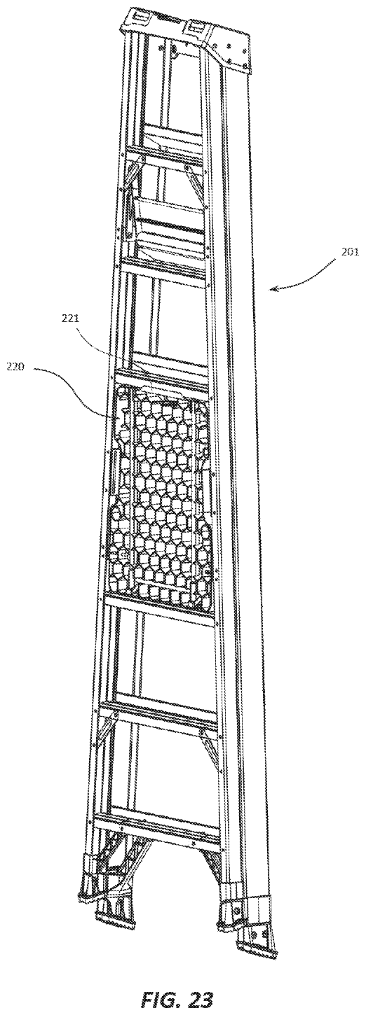

The top view of the system 200 shown in FIG. 20 illustrates one way that the table assembly 220 is different from table assembly 120. The outermost edge of the table assembly 220 is narrower than the width of the platform 224 where the platform is attached to the rear rails 214. In this embodiment, the outermost edge of the platform 224 moves upward when the user transitions the platform 224 from its deployed position (FIGS. 19-20) to its folded position (FIGS. 21-22). The pivot axis (corresponding to 180) is located nearer to the innermost edge at the opposite end of the platform 224 (as compared to the outermost edge of platform 224). The platform 224 still folds into a position substantially filling the space between the rear rails and the braces adjacent to the opening in which the platform 224 extends, as shown in FIGS. 21-23. Accordingly, because the upper brace 216 is narrower than the lower brace 216 for that opening, the outermost edge of the platform 224 is narrower than the innermost edge thereof. This may help ensure that the platform 224 is compact and unobtrusive while stored. As shown in FIG. 23, the ladder 201 may also be folded into its collapsed condition while the table assembly 220 is stored. Similar to table assembly 120, the table assembly 220 may be stored within a volumetric envelope defined by planes coinciding with the front and rear surfaces of the rear rails 214 and/or defined by the opening between the rear rails 214 and adjacent braces 216.

When in the storage or folded configuration, the platform 224 may have its bottom surface/lattice-side surfaces facing outward/rearward from the rear rails 214. The top surface (corresponding to surface 128) may face inward and toward the rungs of the first assembly 202. In this manner, the platform 224 may have its top surface more protected from scratches, scrapes, impacts, or other damage while the table assembly 220 is not being used. The outward exposure of the bottom side of the platform 224 while folded may also make it easier for the user to access the platform support 226 and to rotate it to a supporting position relative to the platform 224 when deploying the assembly 220 since the platform support 226 is visible and accessible from the outside of the ladder 201 when in the folded position.

The platform 224 may comprise a flange 221 extending away from the outermost edge, as shown in FIGS. 20-22. The flange 221 may limit rotation of the platform 224 when it is rotated into a storage position within the rear rails 214, as shown in FIGS. 21-22. The flange 221 may contact and interface with a rear-facing surface of a brace 216, thereby preventing further movement of the platform 224 past the point of contact of the flange 221 and brace 216. Thus, the flange 221 may help keep the platform 224 in its storage position when it is not being used.

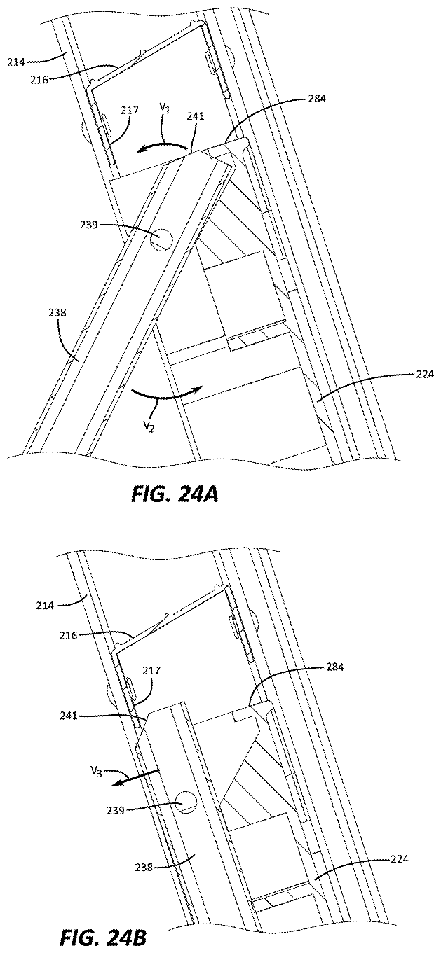

The struts 238 of the platform support 226 may be pivotable relative to the platform 224, similar to struts 138. The rotation of the struts 238 may be used as part of a mechanism for retaining the platform 224 in place relative to the rear rails 214 in conjunction with the flange 221. FIG. 24A shows a section view of the interface between an upper brace 216 and the platform 224 when the platform 224 is first rotated from a deployed condition to its storage position between the rear rails 214. The outer edge 284 of the platform 224 is rotated from its deployed position to the folded position which is past the rear wall 217 of the brace 216. The outer edge 284 is not prevented from rotating to this position because a first end 241 of the strut 238 (positioned opposite the feet) is rotated (about pivot 239) into a position where it lies between the ends of the platform 224 and does not come into contact with the rear wall 217. In some configurations, the first end 241 may comprise a notch or cutoff portion (as is shown in FIG. 24A) to prevent the strut 238 from extending beyond the platform 224 at edge 284 while the strut 238 is deployed. This notch or cutoff portion may also prevent the strut 238 from engaging the rear wall 217 when the platform rotates to the storage position of FIG. 24A (and prior to rotation along direction V₁).

Once the platform 224 reaches the state shown in FIG. 24A, the user may rotate the strut 238 about pivot 239 to cause the first end 241 to extend longitudinally beyond the outer edge 284, as shown by the arrows V₁, V₂ in FIG. 24A. In this rotated position, the strut 238 may be referred to as being in a folded or collapsed configuration, wherein substantially the entire strut 238 (e.g., only excluding the tip of the first end 241) is positioned within the platform 224 (e.g., within channels in its bottom lattice). In this state, the first end 241 protrudes longitudinally beyond the outer edge 284 to a position where rotation of the platform 224 relative to the rails 214 (e.g., along direction V₃) is limited or prevented due to mechanical interaction between the rear wall 217 and the first end 241. Furthermore, forward rotation (i.e., opposite V₃) is also limited or prevented due to the flange 221 engaging the opposite (rear) side of the wall 217. Accordingly, the struts 238 and flange 221 may hold the platform 224 in place relative to the ladder 201 while they are in the folded or storage position. In some embodiments, the struts 138 may have first ends that extend and operate in the same manner as first ends 241, thereby locking platform 124 relative to a brace 116. Additionally, the platform 124 may comprise a flange similar to flange 221 to lock platform 124 in place in the opposite direction (in like manner).

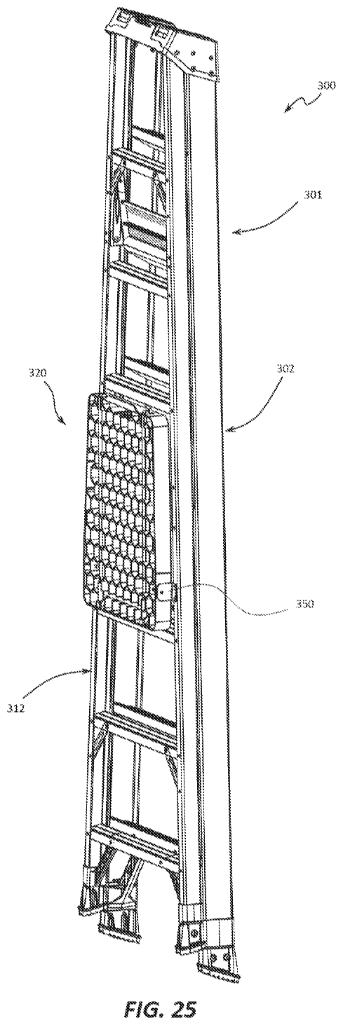

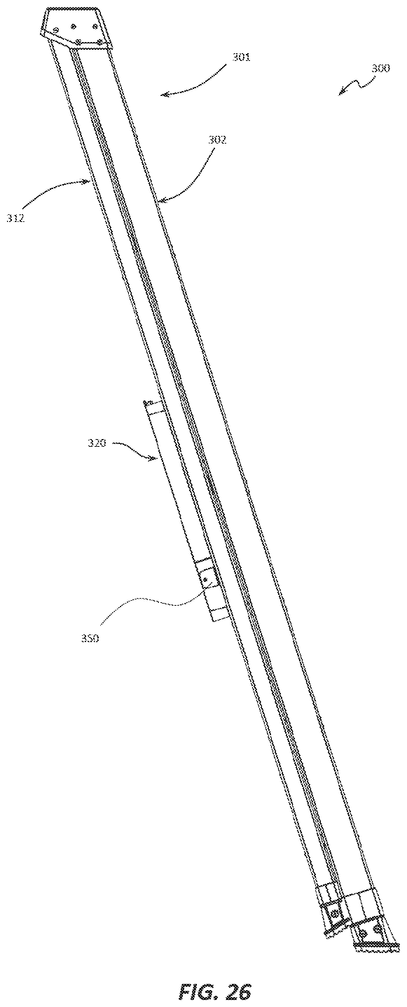

FIGS. 25-27 illustrate a related embodiment of a system 300 including a ladder 301 having a table assembly 320 installed to the rear side of the second assembly 312. For example, the table assembly 320 may be attached to the rear rails of the second assembly 312 using a pair of at least partially rearward-extending brackets 350 that receive pivot pins of the platform of the table assembly 320 and that are mounted to the rear rails (e.g., at rear-facing surfaces of the rear rails). The brackets 350 may be attached to the rear rails at a user-selectable position via fasteners, interlocking parts, adhesives, welding, similar techniques, or combinations thereof. The table assembly 320 may be attached to the second assembly 312 irrespective of the positioning of the braces of the second assembly 312 so as to accommodate attachment of the table assembly 320 to any ladder 301, including a ladder that is not originally designed or intended for connection to a table assembly 320. The brackets 350 may position the platform rearward of the rear surfaces of the rear rails when the platform is in its folded position.

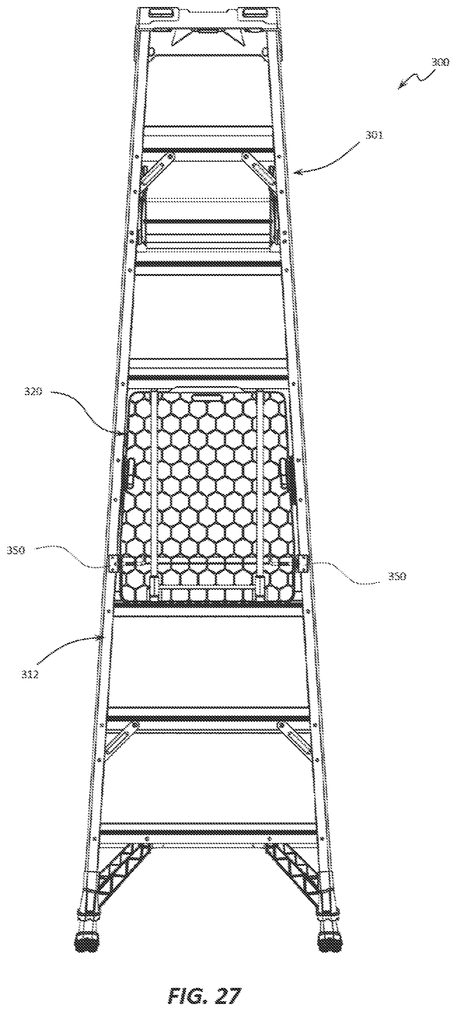

The platform of the table assembly 320 may be rotatable relative to the brackets 350 between a storage or folded configuration (shown in FIGS. 25-27) and a deployed or horizontal configuration extending from the rear rails. The platform may be coupled with a platform support (see FIG. 27) that, when rotated relative to the platform, can engage a brace of the second assembly 312 to hold the platform in a horizontal deployed position.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including: ” and “having” come as used in the specification and claims shall have the same meaning as the term “comprising.” As used in the specification, “and” and “or” shall have the same meaning as “and/or,” wherein, unless context mandates otherwise, these conjunctions can be read inclusively or exclusively.

What is claimed is:

1. A ladder system, comprising:
a ladder, comprising:
a first pair of rails spaced apart from each other;
at least two braces coupled with and extending between the first pair of rails;
a table assembly, comprising:
a platform pivotally coupled with the first pair of rails and rotatable relative to the first pair of rails between a first platform position and a second platform position; and
at least one strut pivotally coupled with the platform and rotatable relative to the platform between a first strut position and a second strut position;
wherein:
when the at least one strut is in the first strut position, the at least one strut is substantially parallel to the platform;
when the platform is in the first platform position, the platform lies substantially entirely between the first pair of rails, the platform lies substantially entirely between the at least two braces, and the at least one strut is in the first strut position;
when the platform is in the second platform position, the platform is substantially horizontally oriented relative to a gravitational direction; and
when the at least one strut is in the second strut position, the at least one strut extends from the platform and contacts the ladder.

2. The ladder system of claim 1, wherein the ladder further comprises a second pair of rails and at least two rungs coupled with an extending between the second pair of rails, the first pair of rails and the second pair of rails being movably coupled with each other between an expanded configuration and a collapsed configuration.

3. The ladder system of claim 1, wherein when the at least one strut is in the second strut position, the at least one strut abuts a brace of the at least two braces.

4. The ladder system of claim 1, further comprising a pair of brackets coupling the platform with the first pair of rails via a pair of pivot pins.

5. The ladder system of claim 4, wherein the pair of brackets is detachable from the platform by operation of the pair of pivot pins.

6. The ladder system of claim 1, wherein the platform includes a pair of lateral side surfaces respectively parallel to the first pair of rails.

7. The ladder system of claim 1, wherein a pivot axis of the platform extends through a bottom half of the platform when the platform is in the first platform position.

8. The ladder system of claim 1, wherein when the platform is in the second platform position, a first portion of the platform extends forward from the first pair of rails and a second portion of the platform extends rearward from the first pair of rails.

9. The ladder system of claim 1, wherein the at least one strut is configured to prevent movement of the platform from the first platform position to the second platform position while the at least one strut is in the first strut position.

10. A ladder, comprising:
a first pair of rails spaced apart from each other;
a second pair of rails spaced apart from each other and rotatably coupled with the first pair of rails;
at least two braces coupled with and extending between the first pair of rails; and
a platform pivotally coupled with the first pair of rails and rotatable relative to the first pair of rails, the platform having a perimeter substantially filling a space defined by the first pair of rails and the at least two braces.

11. The ladder of claim 10, wherein the perimeter defines a trapezoid.

12. The ladder of claim 10, wherein the platform is rotatable about at least one laterally movable pivot pin coupling the platform to at least one rail of the first pair of rails.

13. The ladder of claim 10, wherein the platform is rotatable between a first position filling the space and a second position extending horizontally from the first pair of rails when the first pair of rails and the second pair of rails are in a non-parallel-rail configuration.

14. The ladder of claim 10, wherein the platform is positioned rearward of rear surfaces of the first pair of rails when the platform is in a folded position.

15. The ladder of claim 10, wherein at least one lateral recess of the platform is aligned with a center of gravity of ladder system.

16. The ladder of claim 10, wherein a first end of the platform has a width different from a second end of the platform, the second end being pivotally coupled with the first pair of rails.

17. A platform system for a ladder, the platform system comprising:
a platform defining a top surface, a bottom surface, and a perimeter extending around the top surface;
at least one strut pivotally coupled with the platform by at least one pivotable upper hinge at a first end of the platform; and
at least one pivot pin laterally extending from a second end of the platform, the second end being positioned opposite the first end, the at least one pivot pin being rotatably connectable to a ladder;
wherein:
the at least one strut is movable between a first strut position and a second strut position relative to the platform,
in the first strut position, the at least one strut is collapsed into a volumetric envelope defined between the top surface and the bottom surface,
in the second strut position, the at least one strut extends at an angle away from the bottom surface.

18. The platform system of claim 17, wherein the platform defines at least one channel, the at least one strut being received within the at least one channel while the at least one strut is in the first strut position.

19. The platform system of claim 17, wherein the at least one pivot pin is movable relative to the platform between an extended position and a retracted position.

20. The platform system of claim 17, wherein in the second strut position, the at least one strut is at a non-orthogonal angle relative to the platform.
